(19) United States
(12) Patent Application Publication
(10) Pub. No.: US 2022/0169052 A1
(43) Pub. Date: Jun. 2, 2022

(54) RECORDING DEVICE

(71) Applicant: Seiko Epson Corporation, Tokyo (JP)

(72) Inventor: Tsutomu OZAKI, Matsumoto-shi (JP)

(21) Appl. No.: 17/536,937

(22) Filed: Nov. 29, 2021

(30) Foreign Application Priority Data
Nov. 30, 2020 (JP) 2020-198144

(51) Int. Cl. B41J 13/00; B41J 2/165; B41J 25/304; B41J 2/14; H04N 1/00

(52) U.S. Cl. CPC B41J 13/0009; B41J 2/16505; H04N 1/00082; B41J 2/14; B41J 25/304

(57) ABSTRACT

A housing includes an upstream cover configured to open and close an upstream opening located upstream from a maintenance position in a transport direction, and a downstream cover configured to open and close a downstream opening located downstream from the maintenance position in the transport direction, and a recording head configured to stop at the maintenance position during maintenance is at least partially located, in a width direction, between a transport path and a cap.

The present application is based on, and claims priority from JP Application Serial Number 2020-198144, filed Nov. 30, 2020, the disclosure of which is hereby incorporated by reference herein in its entirety.

### BACKGROUND

### 1. Technical Field

The present disclosure relates to a recording device.

### 2. Related Art

For example, as in JP-A-2019-155649, there is a printer that is an example of a recording device that performs recording on a roll paper that is an example of a recording medium. The printer includes a recording head, a carriage, a capping portion that is an example of a cap, and a housing. The recording head performs recording on the roll paper. The carriage performs scanning in a width direction different from a transport direction of the roll paper. The recording head is mounted on the carriage. The capping portion covers a nozzle surface of the recording head. The housing accommodates the recording head, the carriage, and the capping portion.

Along with movement of the carriage, the recording head moves to a recording region in which the recording head performs recording on the roll paper, a first retraction region that is an example of a maintenance position, and a second retraction region that is an example of a cap position. The first retraction region is a region where the user performs maintenance of the recording head such as wiping off dirt adhering to the recording head. The second retraction region is a region for maintenance of the recording head using a capping unit. The first retraction region is located outside of the recording region in the width direction. The second retraction region is located outside the recording region in a direction opposite to the width direction.

By reducing a dimension of the housing in the width direction, it is possible to reduce a dimension of the recording device. The dimension of the housing in the width direction depends on arrangement aspects of the cap position and the maintenance position in the width direction. Therefore, it is desirable to reduce the dimension of the housing in the width direction by changing these arrangement aspects.

### SUMMARY

A recording device for solving the above-described problems includes a transport path along which a recording medium is transported in a transport direction, a recording head including a nozzle surface at which a nozzle opens, the recording head being configured to perform recording on the recording medium transported in the transport path, a carriage on which the recording head is mounted, the carriage being configured to move in a width direction different from the transport direction, a cap configured to cover the nozzle surface of the recording head located at a cap position, and a housing configured to accommodate the transport path, the recording head, the carriage, and the cap, wherein the housing includes an upstream cover configured to open and close an upstream opening located upstream from a maintenance position in the transport direction, and a downstream cover configured to open and close a downstream opening located downstream from the maintenance position in the transport direction, and the recording head configured to stop at the maintenance position during maintenance is at least partially located, in the width direction, between the transport path and the cap.

### BRIEF DESCRIPTION OF THE DRAWINGS

FIG. 1 is a perspective view illustrating a recording device according to an exemplary embodiment.

FIG. 2 is a schematic view illustrating the recording device.

FIG. 3 is a cross-sectional view of the recording device.

FIG. 4 is a schematic view illustrating the recording device.

FIG. 5 is a schematic view illustrating the recording device when a recording head is in a maintenance position.

FIG. 6 is a perspective view illustrating a downstream cover.

FIG. 7 is a schematic view illustrating a configuration of a housing near a downstream opening.

FIG. 8 is a schematic view illustrating the recording device when the recording head is in the maintenance position.

FIG. 9 is a schematic view illustrating a configuration of the housing near an upstream opening in a state where the upstream cover is in an open position.

### DESCRIPTION OF EXEMPLARY EMBODIMENTS

Hereinafter, an exemplary embodiment of a recording device will be described with reference to the drawings. The recording device of the present exemplary embodiment is, for example, an inkjet printer that discharges ink, which is an example of liquid, to perform printing on a medium such as paper.

In the drawings, a direction of gravity is indicated by the Z-axis, and a direction along a horizontal plane is indicated by the X-axis and the Y-axis, assuming that the recording device is placed at the horizontal plane. The X, Y, and Z-axes are orthogonal to each other. In the following description, a direction parallel to the X-axis is also referred to as a width direction X, a direction parallel to the Y-axis is also referred to as a depth direction Y, and a direction parallel to the Z-axis is also referred to as a vertical direction Z.

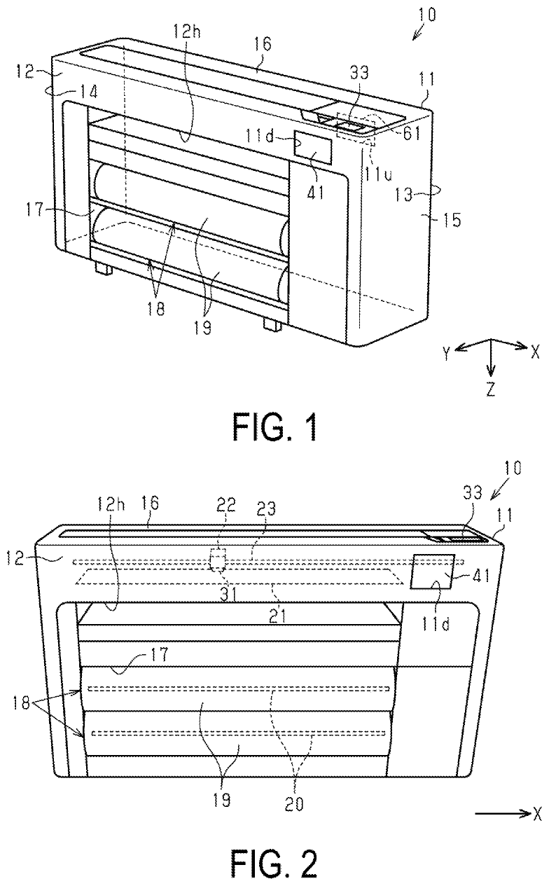

As illustrated in FIG. 1, a recording device 10 includes a substantially rectangular housing 11. The housing 11 includes a front wall 12, a rear wall 13, a first side wall 14, a second side wall 15, and an upper wall 16. The front wall 12 and the rear wall 13 extend in a direction orthogonal to the Y-axis. The first side wall 14 and the second side wall 15 extend in a direction orthogonal to the X-axis. The front wall 12 is located in the depth direction Y with respect to the rear wall 13. The second side wall 15 is located in the width direction X with respect to the first side wall 14. The second side wall 15 is coupled to an end portion of each of the front wall 12 and the rear wall 13 in the width direction X. The first side wall 14 is coupled to an end portion of each of the front wall 12 and the rear wall 13 in a direction opposite to the width direction X. The upper wall 16 extends parallel to the horizontal plane. The upper wall 16 is coupled to each of the front wall 12, the rear wall 13, the first side wall 14, and the second side wall 15 in a direction opposite to the vertical direction Z.

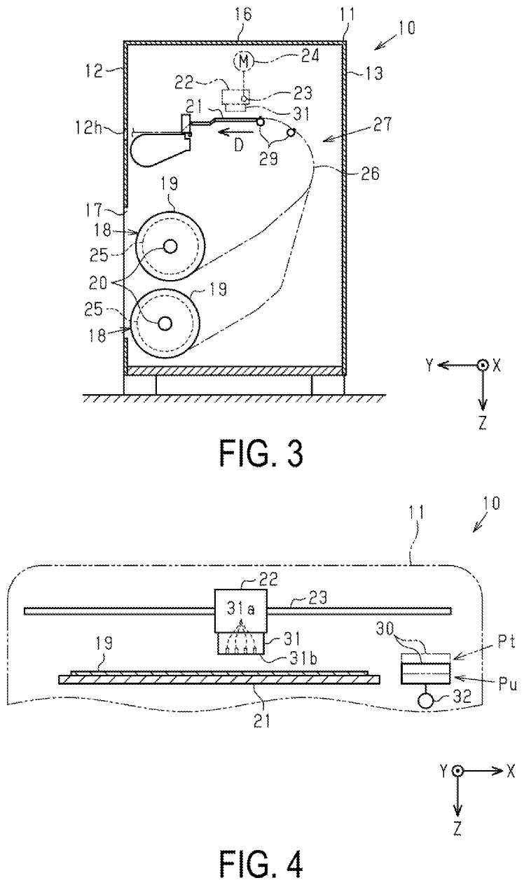

As illustrated in FIGS. 2 and 3, the recording device 10 may include an accommodating unit 17 that accommodates a cylindrical roll body 18. The roll body 18 is formed by winding a recording medium 19 around a core member 20. The accommodating unit 17 is capable of accommodating a plurality of roll bodies 18. Both ends of each roll body 18 in the width direction X are rotatably mounted on a holding portion (not illustrated) of the accommodating unit 17. The accommodating unit 17 is open at a portion of the vertical direction Z of the front wall 12 of the housing 11. The accommodating unit 17 constitutes a portion of an internal space of the housing 11 in the vertical direction Z.

The recording device 10 may include a plate-like support stand 21 inside the housing 11. The support stand 21 is located above the accommodating unit 17. A dimension in the width direction X of the support stand 21 is greater than a dimension in the width direction X of the recording medium 19. The support stand 21 can support the recording medium 19 at an upper surface.

Carriage 22

As illustrated in FIG. 3, the recording device 10 includes a carriage 22 that moves in the width direction X. The housing 11 accommodates the carriage 22. The carriage 22 is supported by a rod-like guide shaft 23 that extends in the width direction X. The recording device 10 may include a carriage motor 24. The carriage motor 24 is driven to allow the carriage 22 to reciprocate along the guide shaft 23. The carriage 22 and the guide shaft 23 are located above the support stand 21.

Feed and Transport of Recording Medium 19

As illustrated in FIG. 3, the recording device 10 may include a drive motor 25, and a transport unit 27 configured to transport the recording medium 19 along a transport path 26 illustrated by a dot-dash line in the drawing. That is, the recording device 10 may also include the transport path 26. The housing 11 accommodates the transport path 26. The transport path 26 may include the support stand 21. The transport path 26 leads to an outlet 12h that is open to the front wall 12.

The roll body 18 rotates by driving of the drive motor 25. As the roll body 18 rotates, the recording medium 19 is unwound from the roll body 18 and fed to the transport path 26. The transport unit 27 may include a plurality of transport roller pairs 29. By rotating the transport roller pairs 29 with the recording medium 19 interposed therebetween, the recording medium 19 is transported in a transport direction D in the transport path 26. The transport direction D is a direction along the transport path 26.

Recording Head 31

As illustrated in FIG. 4, the recording device 10 includes a recording head 31 configured to perform recording on the recording medium 19. The housing 11 accommodates the recording head 31. The recording head 31 has a nozzle surface 31b at which a nozzle 31a is opened. The nozzle surface 31b may be a horizontal plane.

The carriage 22 includes the recording head 31. The recording head 31 is movable reciprocally in the width direction X and in a direction opposite to the width direction X by moving with the carriage 22. The recording head 31 moves at positions above the support stand 21 and spaced apart from the support stand 21. The nozzle surface 31b may be parallel to the upper surface of the support stand 21. The recording head 31 may perform recording on the recording medium 19 by discharging liquid from the nozzle 31a onto the recording medium 19 on the support stand 21. Note that the transport direction D on the support stand 21 is parallel to the Y-axis. The carriage 22, which moves above the support stand 21 in the width direction X, moves in a direction different from the transport direction D.

Cap 30

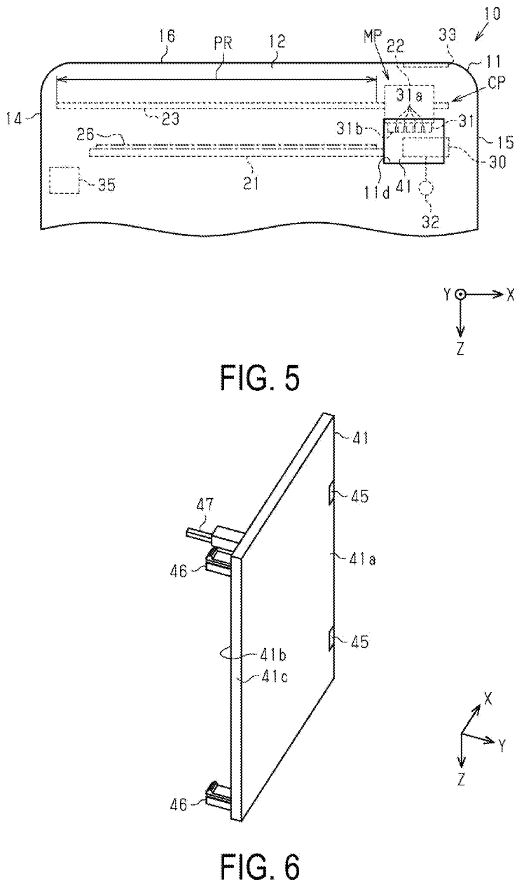

As illustrated in FIG. 4, the recording device 10 includes the cap 30 that covers the nozzle surface 31b. The housing 11 accommodates the cap 30. The cap 30 may be reciprocally movable along the Z-axis by the cap motor 32. As the cap 30 moves by the cap motor 32, the cap 30 moves upwardly or downwardly. The cap 30 moves between a remote position Pu, which is a lower position, and a contact position Pt, which is an upper position. Above the cap 30 is a cap position CP of the recording head 31 (see FIG. 5). When the cap 30 is in the contact position Pt, the cap 30 contacts the recording head 31 that stops the cap position CP.

The cap 30 covers the nozzle surface 31b to enclose an opening of the nozzle 31a of the recording head 31. In this manner, the maintenance by which the cap 30 encloses an opening of the nozzle 31a is referred to as capping. By the capping, drying of the nozzle 31a is suppressed. The cap 30 may be configured to collectively enclose all of the nozzles 31a that are open to the nozzle surface 31b.

Operation Unit 33

As illustrated in FIG. 5, the recording device 10 may include an operation unit 33 on the upper wall 16 of the housing 11. The operation unit 33 is constituted by, for example, a touch panel, etc., and is used when the user inputs various information. Examples of the various information input to the operation unit 33 by the user include various types of information in the recording to the recording medium 19, the start of recording on the recording medium 19, and the execution of various maintenance. The execution of various maintenance includes maintenance of the recording head 31. The input of various types of information into the operation unit 33 may be performed by the user touching various menus displayed in the operation unit 33.

Control Unit 35

As illustrated in FIG. 5, the recording device 10 may include a control unit 35. The control unit 35 may be configured as a circuit including α: one or more processors for performing various processes according to a computer program, β: one or more dedicated hardware circuits such as application-specific integrated circuits that perform at least some processing of various processes, or γ: combinations thereof. The processor includes a CPU and a memory such as a RAM and a ROM, and the memory stores a program code or an instruction configured to cause the CPU to execute a process. The memory, i.e. a computer-readable medium, includes any readable medium that can be accessed by a general-purpose or dedicated computer.

The control unit 35 may control various operation performed on the recording device 10. The control unit 35 may control the movement and stopping of the carriage 22 by controlling the driving of the carriage motor 24 based on input to the operation unit 33 by the user. The recording head 31 moves between a recording region PR and the cap position CP as the carriage 22 moves, and stops at a maintenance position MP as the carriage 22 stops.

The recording region PR is a region in which the nozzle surface 31b overlaps with the transport path 26 in a direction orthogonal to the nozzle surface 31b. Specifically, the recording region PR is a region in which the nozzle surface 31b overlaps with the transport path 26 on the support stand 21 in a direction parallel with the Z-axis. The dimension in the width direction X of the recording region PR coincides with the dimension in the width direction X in a placement space of the recording medium 19 on the support stand 21. The recording head 31 may perform recording on the recording medium 19 while moving the recording region PR.

The cap position CP is a position spaced apart from the recording region PR in the width direction X. The cap position CP is a home position of the recording head 31. The recording head 31 uses the cap position CP as a starting point for movement.

When the user performs input on the operation unit 33 to start recording to the recording medium 19, the control unit 35 initiates driving of the carriage motor 24. As a result, the recording head 31 discharges the liquid while reciprocating in the recording region PR to perform recording on the recording medium 19. When recording to the recording medium 19 is complete, the control unit 35 moves the recording head 31 in the width direction X to the cap position CP. The control unit 35 stops driving of the carriage motor 24, whereby the recording head 31 stops at the cap position CP.

The control unit 35 initiates the driving of the cap motor 32 at a timing when the recording head 31 is located at the cap position CP. This causes the cap 30 to move from the remote position Pu. The control unit 35 stops the driving of the cap motor 32 when the cap 30 moves to the contact position Pt. This causes the cap 30 to stop at the contact position Pt. The recording head 31 stops at the cap position CP and the cap 30 stops at the contact position Pt, whereby the capping is performed in which the cap 30 covers the nozzle surface 31b. The control unit 35 initiates the driving of the cap motor 32 when the recording head 31 moves from the cap position CP. This causes the cap 30 to move from the contact position Pt. The control unit 35 stops the driving the cap motor 32 when the cap 30 moves to the remote position Pu. This causes the cap 30 to stop at the remote position Pu.

The control unit 35 may stop the carriage 22 at a position such that the recording head 31 is at the maintenance position MP, provided that the control unit 35 receives an instruction from the user to perform maintenance on the recording head 31. The control unit 35 determines that the user has performed an instruction to perform maintenance on the recording head 31 when the user has input to the operation unit 33 to perform maintenance on the recording head 31.

During maintenance of the recording head 31, first, the control unit 35 initiates driving of the carriage motor 24, whereby the recording head 31 moves in a direction opposite to the width direction X from the cap position CP. The control unit 35 stops the driving of the carriage motor 24 at a timing when the recording head 31 reaches the maintenance position MP.

The maintenance position MP is a position between the recording region PR and the cap position CP in the width direction X. The recording head 31 that stops at the maintenance position MP during maintenance is at least partially located, in the width direction X, between the transport path 26 and the cap 30. The nozzle surface 31b of the recording head 31 when stopped at the maintenance position MP may be located outside the recording region PR in the width direction X. In a case where the recording head 31 stops at the maintenance position MP, a portion of the nozzle surface 31b in the width direction X may overlap with a portion of the nozzle surface 31b when the recording head 31 stops at the cap position CP.

The control unit 35 initiates the driving of the cap motor 32 when the recording head 31 initiates moving from the cap position CP toward the maintenance position MP. This causes the cap 30 to move from the contact position Pt. When the recording head 31 stops at the maintenance position MP, the cap 30 is located at a position between the contact position Pt and the remote position Pu, or at the remote position Pu. Thus, when the recording head 31 is in the maintenance position MP, the cap 30 is spaced apart from the nozzle surface 31b.

Downstream Cover 41

As illustrated in FIG. 5, the housing 11 includes a downstream cover 41 that can open and close a downstream opening 11d. The downstream opening 11d may be located at the front wall 12 of the housing 11, such that the downstream cover 41 may be disposed at the front wall 12 of the housing 11. The downstream opening 11d is located downstream from the maintenance position MP in the transport direction D. As a result, the downstream cover 41 is located downstream from the maintenance position MP in the transport direction D.

As illustrated in FIG. 6, the downstream cover 41 may include a support portion 45, a claw portion 46, and a protruding portion 47. In a state where the downstream cover 41 closes the downstream opening 11d, an end portion of the downstream cover 41 in the width direction X is referred to as a first downstream end 41a. Two support portions 45 are located along the first downstream end 41a. The support portion 45 rotatably supports the downstream cover 41 with respect to the housing 11 about a rotation axis that extends parallel to the first downstream end 41a. The downstream cover 41 is movable to a closed position at which the downstream opening 11d of the housing 11 is covered and an open position at which the downstream opening 11d is opened. The claw portion 46 and the protruding portion 47 are located at a downstream inner surface 41b, which is an inner surface of the downstream cover 41. Two claw portions 46 are aligned along a second downstream end 41c located opposite the first downstream end 41a of the downstream cover 41.

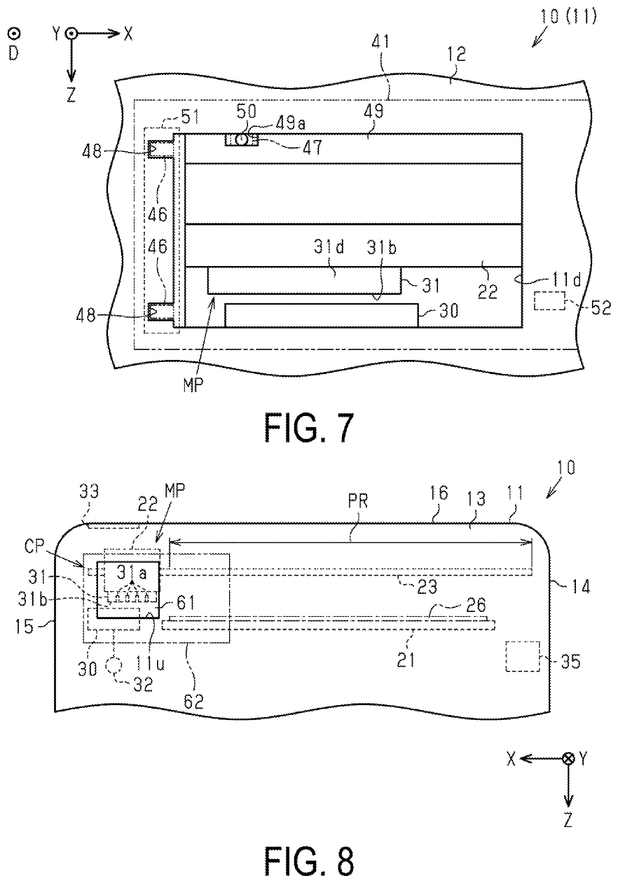

As illustrated in FIG. 7, the recording head 31 may include a downstream surface 31d located downstream in the transport direction D of the recording head 31. When the recording head 31 stops at the maintenance position MP, the downstream cover 41 faces the downstream surface 31d of the recording head 31. The downstream surface 31d is coupled to an edge portion of the nozzle surface 31b downstream of the transport direction D. The downstream surface 31d is exposed to an exterior of the housing 11 via the downstream opening 11d when the downstream cover 41 is in the open state and the recording head 31 stops at the maintenance position MP.

Upstream Cover 61

As illustrated in FIG. 8, the housing 11 includes an upstream cover 61 that can open and close an upstream opening 11u. The upstream opening 11u may be located at the rear wall 13 of the housing 11, such that the upstream cover 61 may be disposed at the rear wall 13 of the housing 11. The upstream opening 11u is located upstream from the maintenance position MP in the transport direction D. As a result, the upstream cover 61 is located upstream from the maintenance position MP in the transport direction D.

The housing 11 may include an interface cover 62 that covers the upstream cover 61 from an exterior of the housing 11. The interface cover 62 covers the rear wall 13 around the upstream cover 61, including the upstream cover 61. Opening the interface cover 62 allows the upstream cover 61 to be opened.

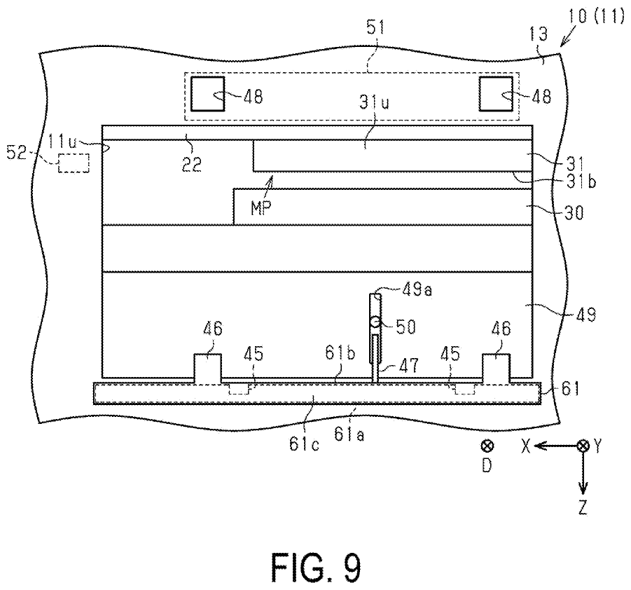

As illustrated in FIG. 9, the upstream cover 61 may include the support portion 45, the claw portion 46, and the protruding portion 47. In a state where the upstream cover 61 closes the upstream opening 11u, a lower end of the upstream cover 61 is referred to as a first upstream end 61a. Two support portions 45 are located along the first upstream end 61a. The support portion 45 rotatably supports the upstream cover 61 with respect to the housing 11 about a rotational axis that extends parallel to the first upstream end 61a. The upstream cover 61 is movable to a closed position at which the upstream opening 11u of the housing 11 is covered and an open position at which the upstream opening 11u is opened. The claw portion 46 and the protrusion portion 47 are located at an upstream inner surface 61b, which is an inner surface of the upstream cover 61. Two claw portions 46 are aligned along a second upstream end 61c located opposite the first upstream end 61a of the upstream cover 61.

The recording head 31 may include an upstream surface 31u located upstream in the transport direction D of the recording head 31. When the recording head 31 stops at the maintenance position MP, the upstream cover 61 faces the upstream surface 31u of the recording head 31 in the depth direction Y. The upstream surface 31u is coupled to an edge portion of the nozzle surface 31b upstream of the transport direction D. The upstream surface 31u is exposed to an exterior of the housing 11 via the upstream opening 11u when the upstream cover 61 is in the open state and the recording head 31 stops at the maintenance position MP.

Structure of Housing 11 Near Downstream Cover 41 and Upstream Cover 61

As illustrated in FIGS. 7 and 9, the housing 11 may include a receiving portion 48 into which the claw portion 46 is insertable. The receiving portion 48 is a through-hole that penetrates through each of the front wall 12 and the rear wall 13, and two receiving portions 48 are provided in each of the front wall 12 and the rear wall 13.

The housing 11 may include an internal member 49 therein. The internal member 49 faces an upper side of the downstream opening 11d and below the upstream opening 11u. The internal member 49 includes a through-hole 49a that passes through the internal member 49.

When the downstream cover 41 and the upstream cover 61 are in the closed position, the claw portion 46 is inserted into each of the receiving portion 48, and the protrusion portion 47 is inserted into the through-hole 49a. When the claw portion 46 is inserted into the receiving portion 48, the claw portion 46 engages with the front wall 12 and the rear wall 13 via the receiving portion 48. This inhibits the downstream cover 41 and the upstream cover 61 from being easily released except when they are released by the user.

The recording device 10 may include an interlock sensor 50 within the housing 11. The interlock sensor 50 is aligned in the depth direction Y with the through-hole 49a of the internal member 49. When the protrusion portion 47 of the downstream cover 41 is inserted into the through-hole 49a, the interlock sensor 50 detects that the downstream cover 41 is in the closed position. When the protrusion portion 47 of the downstream cover 41 is not inserted into the through-hole 49a, the interlock sensor 50 detects that the downstream cover 41 is in the open position. When the protrusion portion 47 of the upstream cover 61 is inserted into the through-hole 49a, the interlock sensor 50 detects that the upstream cover 61 is in the closed position. When the protrusion portion 47 of the upstream cover 61 is not inserted into the through-hole 49a, the interlock sensor 50 detects that the upstream cover 61 is in the open position. The interlock sensor 50 outputs a signal to the control unit 35 in accordance with the open/closed state of the downstream cover 41 and the upstream cover 61.

The housing 11 may include a locking member 51. The locking member 51 is displaceable between a locked state where the downstream cover 41 and the upstream cover 61 are locked in a closed state and an unlocked state where the locked state is released. A plurality of locking members 51 may be disposed at the housing 11 corresponding to each of the downstream cover 41 and the upstream cover 61. The locking member 51 may lock the downstream cover 41 in the closed state by locking the claw portion 46 of the downstream cover 41 inserted into the receiving portion 48. The locking member 51 may lock the upstream cover 61 in the closed state by locking the claw portion 46 of the upstream cover 61 inserted in the receiving portion 48.

The recording device 10 may include an illumination unit 52 that illuminates the recording head 31 at the maintenance position MP. The illumination portion 52 turns on a light when at least one of the upstream cover 61 and the downstream cover 41 is in the open state. Switching of the locked state and the unlocked state in the locking member 51 and switching of turning on and off of the illumination unit 52 may be controlled by the control unit 35.

Control Associated with Opening and Closing of Downstream Cover 41 and Upstream Cover 61

The control unit 35 may switch the locking member 51 from the locked state to the unlocked state when the recording head 31 stops at the maintenance position MP. As a result, the locking member 51 is displaced from the locked state to the unlocked state when the recording head 31 stops at the maintenance position MP. The user will be able to open the downstream cover 41 and the upstream cover 61.

Under the condition that the locking member 51 is in the unlocked state, the control unit 35 may switch the locking member 51 to the locked state, provided that a signal indicating that both the downstream cover 41 and the upstream cover 61 are in the closed state is received from the interlock sensor 50. By switching the lock member 51 from the unlocked state to the locked state, both the downstream cover 41 and the upstream cover 61 may be locked in the closed state.

Note that the condition for the control unit 35 to switch the locking member 51 to the locked state is not limited to a condition in which a signal indicating that both the downstream cover 41 and the upstream cover 61 are in the closed state is received from the interlock sensor 50. For example, the control unit 35 may switch the locking member 51 to the locked state, provided that a signal indicating that both the downstream cover 41 and the upstream cover 61 are in the closed state for a predetermined period of time is received from the interlock sensor 50. The control unit 35 may switch the locking member 51 from the unlocked state to the locked state, provided that a signal indicating that both the downstream cover 41 and the upstream cover 61 are in a closed state is received from the interlock sensor 50, and that the user has performed operation other than maintenance of the recording head 31 on the operation unit 33.

When a signal indicating that at least one of the upstream cover 61 and the downstream cover 41 is in the open state is received from the interlock sensor 50, the control unit 35 may determine that at least one of the upstream cover 61 and the downstream cover 41 has been moved to the open position by the user, and may cause the lighting unit 52 to be on. When a signal indicating that both the upstream cover 61 and the downstream cover 41 are in the closed state is received from the interlock sensor 50, the control unit 35 may determine that both the upstream cover 61 and the downstream cover 41 has been moved to the closed position by the user, and may cause the lighting unit 52 to be off. That is, the illumination unit 52 may turn off a light when both the upstream cover 61 and the downstream cover 41 are in the closed state.

When a signal indicating that both the upstream cover 61 and the downstream cover 41 are in the closed state is received from the interlock sensor 50, the control unit 35 may initiate movement of the carriage 22 by initiating the driving of the carriage motor 24. That is, the carriage 22 may start movement of the recording head 31 from the maintenance position MP to the cap position CP when both the upstream cover 61 and the downstream cover 41 are in the open state to the closed state. Note that the control unit 35 may perform the start of movement of the carriage 22 after the locking member 51 has been switched to the locked state.

### Effect of Present Exemplary Embodiment

Next, actions of the present exemplary embodiment will be described.

Upon maintenance of the recording head 31, when the user operates the operation unit 33, the control unit 35 causes the recording head 31 to move from the cap position CP to the maintenance position MP by initiating the driving of the carriage motor 24. The control unit 35 stops the recording head 31 at the maintenance position MP.

When the recording head 31 stops at the maintenance position MP, the user can perform maintenance on the nozzle surface 31b and the upstream surface 31u of the recording head 31 via the upstream opening 11u by setting the upstream cover 61 to the open state.

When the recording head 31 stops at the maintenance position MP, the user can perform maintenance on the nozzle surface 31b and the downstream surface 31d of the recording head 31 via the downstream opening 11d by setting the downstream cover 41 to the open state.

### Effects of Present Exemplary Embodiment

Effects of the present exemplary embodiment will now be described.

(1) When the recording head 31 stops at the maintenance position MP, the user can perform maintenance on the recording head 31 via the upstream opening 11u by setting the upstream cover 61 to the open state. When the recording head 31 stops at the maintenance position MP, the user can perform maintenance on the recording head 31 via the downstream opening 11d by setting the downstream cover 41 to the open state. The recording head 31 that stops at the maintenance position MP during maintenance is at least partially located, in the width direction X, between the transport path 26 and the cap 30. Therefore, the dimension of the housing 11 in the width direction X can be reduced compared to a case where the cap position CP is a position outside of the transport path 26 in the width direction X and the maintenance position MP is a position outside the transport path 26 in the direction opposite to the width direction X.

(2) The upstream surface 31u of the recording head 31 is exposed to the exterior of the housing 11 via the upstream opening 11u when the upstream cover 61 is in the open state and the recording head 31 stops at the maintenance position MP. The downstream surface 31d of the recording head 31 is exposed to the exterior of the housing 11 via the downstream opening 11d when the downstream cover 41 is in the open state and the recording head 31 stops at the maintenance position MP. As a result, the user can perform maintenance on the upstream surface 31u while viewing the upstream surface 31u of the recording head 31 through the upstream opening 11u of the housing 11. The user can perform maintenance on the downstream surface 31d while viewing the downstream surface 31d of the recording head 31 via the downstream opening 11d of the housing 11. Thus, maintenance efficiency of the upstream surface 31u and the downstream surface 31d of the recording head 31 by the user can be improved.

(3) The control unit 35 stops the carriage 22 at a position such that the recording head 31 is at the maintenance position MP, provided that the control unit 35 receives an instruction from the user to perform maintenance on the recording head 31. Thus, compared to a case where the recording head 31 stops at the maintenance position MP periodically, it is possible to shorten a time for the user to wait between a time when the user tries to perform maintenance on the recording head 31 and a time when the recording head 31 stops at the maintenance position MP. Thus, during maintenance of the recording head 31, the operation efficiency of the user can be improved.

(4) The housing 11 includes the locking member 51 that is displaceable between the locked state where both the upstream cover 61 and the downstream cover 41 are locked in the closed state and the unlocked state where the locked state is released. The locking member 51 is displaced from the locked state to the unlocked state when the recording head 31 stops at the maintenance position MP. As a result, the user can suppress the displacement of the upstream cover 61 and the downstream cover 41 from the closed state to the open state while the recording head 31 is moved to the maintenance position MP. Thus, during movement of the recording head 31, maintenance of the recording head 31 by the user can be suppressed.

(5) The recording device 10 includes the illumination unit 52 that illuminates the recording head 31 at the maintenance position MP. The illumination portion 52 turns on a light when at least one of the upstream cover 61 and the downstream cover 41 is in the open state. Thus, with the illumination unit 52 illuminating the recording head 31, the user can perform maintenance on the recording head 31. Thus, during maintenance of the recording head 31, the operation efficiency of the user can be improved.

(6) When the upstream cover 61 and the downstream cover 41 are in the open state to the closed state, the illuminated portion 52 turns off a light and the carriage 22 initiates movement of the recording head 31 to the cap position CP. Therefore, after the maintenance of the recording head 31 has ended, the user does not need to perform operation for causing the illumination unit 52 to be off and moving the recording head 31, apart from the operation of setting the upstream cover 61 and the downstream cover 41 to the closed state. Thus, during maintenance of the recording head 31, the operation efficiency of the user can be improved.

The present exemplary embodiment described above may be modified as follows. The present exemplary embodiment and modification examples below may be implemented in combination within a range in which a technical contradiction does not arise.
The locking member 51 may lock one of the upstream cover 61 and the downstream cover 41 in the closed state. The housing 11 may not include the locking member 51.
The carriage 22 may stop when at least one of the upstream cover 61 and the downstream cover 41 is in the open state.

According to the above modification example, the following effects can be obtained in addition to the effects of (1) to (3), (5), and (6) of the above exemplary embodiments.

(7) During movement of the recording head 31, when the user displaces at least one of the upstream cover 61 and the downstream cover 41 from the closed state to the open state, the recording head 31 stops. Therefore, it is possible to prevent the user from performing maintenance on the recording head 31 while the recording head 31 is moving.
The recording device 10 may include a cam that moves the cap 30 located at the remote position Pu to the contact position Pt by being pushed by the carriage 22 moving in the width direction X. In this case, as the recording head 31 moves closer to the cap position CP, the cap 30 gradually moves upward toward the contact position Pt. At the timing when the recording head 31 is located at the cap position CP, the cap 30 moves to the contact position Pt and stops at the contact position Pt. The recording head 31 stops at the cap position CP and the cap 30 stops at the contact position Pt, whereby the capping is performed in which the cap 30 covers the nozzle surface 31b. As the recording head 31 moves and approaches the maintenance position MP from the cap position CP, the cap 30 gradually moves downward. At the timing when the recording head 31 is located at the maintenance position MP, the cap 30 is located at a position between the contact position Pt and the remote position Pu, or at the remote position Pu. When the recording head 31 stops the maintenance position MP and the maintenance is performed on the recording head 31, the recording head 31 and the cap 30 are spaced apart from each other.
Turning on and off of the illumination unit 52 may be performed based on the operation of the operation unit 33 by the user.
Two illumination portions 52 may be disposed near the upstream cover 61 and near the downstream cover 41. In this case, one of the illumination portions 52 may be on when the upstream cover 61 is in the open state. The other illumination unit 52 may be on when the downstream cover 41 is in the open state. The recording device 10 may not include the illumination unit 52.
The user may perform various controls on the control unit 35 by communicating with the control unit 35 using a communication device in accordance with the operation of the operation unit 33. In this case, the 35 determines that the control unit 35 is instructed to perform maintenance on the recording head 31 from the user based on communication with the user using the communication device.
The nozzle surface 31b may be an inclined surface inclined with respect to the horizontal plane. In this case, for example, the upper wall 16 of the housing 11 may be located upstream of the maintenance position MP in the transport direction D, as well as the front wall 12 of the housing 11 may be located downstream of the maintenance position MP in the transport direction D. In such cases, the upstream cover 61 may be disposed at the upper wall 16 of the housing 11. The downstream cover 41 may be disposed at the front wall 12 of the housing 11.
A portion of the recording head 31 exposed to the exterior of the housing 11 via the upstream opening 11u is not limited to the upstream surface 31u when the upstream cover 61 is in the open state and the recording head 31 stops at the maintenance position MP. In short, when the upstream opening 11u is located upstream of the maintenance position MP in the transport direction D, maintenance of the recording head 31 stopped at the maintenance position MP can be performed via the upstream opening 11u. A portion of the recording head 31 exposed to the exterior of the housing 11 via the downstream opening 11d is not limited to the downstream surface 31d when the downstream cover 41 is in the open state and the recording head 31 stops at the maintenance position MP. In short, when the downstream opening 11d is located downstream from the maintenance position MP in the transport direction D, maintenance of the recording head 31 stopped at the maintenance position MP can be performed via the downstream opening 11d.
The recording device 10 may be a liquid jet device that sprays or discharges other liquid other than ink to perform recording. The state of the liquid discharged from the liquid jet device to become a small amount of droplets includes granules, tears, and string-like tails. The liquid described herein may be any material that can be sprayed from the liquid jet device. For example, the liquid may be in a state when the substance is a liquid phase, and includes a fluid body such as a liquid body with high or low viscosity, sol, gel water, other inorganic solvents, organic solvents, solutions, liquid resins, liquid metals, metal melts. The liquid includes not only liquid as one state of the substance, but also particles of functional materials consisting of solid substances such as pigments or metal particles being dissolved, dispersed, or mixed in a solvent. Representative examples of the liquid include ink, liquid crystals, etc. described in the above exemplary embodiments. Here, the ink includes general water-based ink, oil-based ink, and various liquid compositions such as gel ink and hot melt ink. Specific examples of the liquid jet device include, for example, a device that sprays liquid containing materials such as electrode materials and color materials used in the manufacture of liquid crystal displays, electroluminescence displays, surface emitting displays, color filters, etc. in a dispersed or dissolved form. The liquid jet device may be a device that sprays a bioorganic substance used for producing a biochip, a device that sprays liquid as a sample used as a precision pipette, a printing device, a micro dispenser, etc. The liquid jet device may be a device that pinpointly sprays lubricating oil into precision machinery such as watches and cameras, and a device that sprays transparent resin liquid such as an ultraviolet curable resin onto a substrate to form a microhemispherical lens, an optical lens, etc. used for an optical communication element, etc. The liquid jet device may be a device that sprays etching solution, such as an acid or alkali, to etch a substrate, etc.

Hereinafter, technical concepts and effects thereof that are understood from the above-described exemplary embodiments and modification examples will be described.

A recording device includes a transport path along which a recording medium is transported in a transport direction, a recording head including a nozzle surface at which a nozzle opens, the recording head being configured to perform recording on the recording medium transported in the transport path, a carriage on which the recording head is mounted, the carriage being configured to move in a width direction different from the transport direction, a cap configured to cover the nozzle surface of the recording head located at a cap position, and a housing configured to accommodate the transport path, the recording head, the carriage, and the cap, wherein the housing includes an upstream cover configured to open and close an upstream opening located upstream from a maintenance position in the transport direction, and a downstream cover configured to open and close a downstream opening located downstream from the maintenance position in the transport direction, and the recording head configured to stop at the maintenance position during maintenance is at least partially located, in the width direction, between the transport path and the cap.

According to this configuration, when the recording head stops at the maintenance position, the user can perform maintenance on the recording head via the upstream opening by setting the upstream cover to the open state. When the recording head stops at the maintenance position, the user can perform maintenance on the recording head via the downstream opening by setting the downstream cover to the open state. The recording head that stops at the maintenance position during maintenance is at least partially located, in the width direction, between the transport path and the cap. Therefore, the dimension of the housing in the width direction can be reduced compared to a case where the cap position is a position outside of the transport path in the width direction and the maintenance position is a position outside the transport path in the direction opposite to the width direction.

(B) In the recording device, the recording head may include an upstream surface located upstream in the transport direction and a downstream surface located downstream in the transport direction, the upstream surface may be exposed to an exterior of the housing via the upstream opening when the upstream cover is in an open state and the recording head stops at the maintenance position, and the downstream surface may be exposed to an exterior of the housing via the downstream opening when the downstream cover is in an open state and the recording head stops at the maintenance position.

According to this configuration, the user can perform maintenance on the upstream surface while viewing the upstream surface of the recording head via the upstream opening of the housing. The user can perform maintenance on the downstream surface while viewing the downstream surface of the recording head via the downstream opening of the housing. Thus, maintenance efficiency of the upstream surface and the downstream surface of the recording head by the user can be improved.

(C) In the recording device, the nozzle surface may be a horizontal plane, the upstream cover may be disposed at a rear wall of the housing, and the downstream cover may be disposed at a front wall of the housing.

(D) The recording device may include a control unit configured to control movement and stopping of the carriage, wherein the control unit may be configured to stop the carriage at a position such that the recording head is at the maintenance position, provided that the control unit receives an instruction from a user to perform maintenance on the recording head.

According to this configuration, compared to a case where the recording head stops at the maintenance position periodically, it is possible to shorten a time for the user to wait between a time when the user tries to perform maintenance on the recording head and a time when the recording head stops at the maintenance position. Thus, during maintenance of the recording head, the operation efficiency of the user can be improved.

(E) In the recording device, the housing may include a locking member configured to perform displacement between a locked state where at least one of the upstream cover and the downstream cover is locked in a closed state and an unlocked state where the locked state is released, and the locking member may be displaced from the locked state to the unlocked state when the recording head stops at the maintenance position.

According to this configuration, the user can suppress the displacement of the upstream cover and the downstream cover from the closed state to the open state while the recording head is moved to the maintenance position. Thus, during movement of the recording head, maintenance of the recording head by the user can be suppressed.

(F) In the recording device, the carriage may stop when at least one of the upstream cover and the downstream cover is in the open state.

According to this configuration, when the user displaces at least one of the upstream cover and the downstream cover from the closed state to the open state while the recording head is moving, the recording head stops. Therefore, it is possible to prevent the user from performing maintenance on the recording head while the recording head is moving.

(G) The recording device may further include an illumination unit configured to illuminate the recording head at the maintenance position, wherein the illumination unit may be configured to be on when at least one of the upstream cover and the downstream cover is in an open state.

Thus, with the illumination unit illuminating the recording head, the user can perform maintenance on the recording head. Thus, during maintenance of the recording head, the operation efficiency of the user can be improved.

(H) In the recording device, the illumination unit may be configured to be off when both the upstream cover and the downstream cover are in a closed state, and the carriage may be configured to start movement of the recording head to the cap position when both the upstream cover and the downstream cover are brought into a closed state from an open state.

According to this configuration, when the upstream cover and the downstream cover are in the open state to the closed state, the illuminated portion turns off a light and the carriage initiates movement of the recording head to the cap position. Therefore, after the maintenance of the recording head has ended, the user does not need to perform operation for turning off the illumination unit and moving the recording head, apart from the operation of setting the upstream cover and the downstream cover to the closed state. Thus, during maintenance of the recording head, the operation efficiency of the user can be improved.

What is claimed is:

1. A recording device comprising:
a transport path along which a recording medium is transported in a transport direction;
a recording head including a nozzle surface at which a nozzle opens, the recording head being configured to perform recording on the recording medium transported in the transport path;
a carriage on which the recording head is mounted, the carriage being configured to move in a width direction different from the transport direction;
a cap configured to cover the nozzle surface of the recording head located at a cap position; and
a housing configured to accommodate the transport path, the recording head, the carriage, and the cap, wherein
the housing includes an upstream cover configured to open and close an upstream opening located upstream from a maintenance position in the transport direction, and a downstream cover configured to open and close a downstream opening located downstream from the maintenance position in the transport direction, and
the recording head configured to stop at the maintenance position during maintenance is at least partially located, in the width direction, between the transport path and the cap.

2. The recording device according to claim 1, wherein
the recording head includes an upstream surface located upstream in the transport direction and a downstream surface located downstream in the transport direction,
the upstream surface is exposed to an exterior of the housing via the upstream opening when the upstream cover is in an open state and the recording head stops at the maintenance position, and
the downstream surface is exposed to an exterior of the housing via the downstream opening when the downstream cover is in an open state and the recording head stops at the maintenance position.

3. The recording device according to claim 1, wherein
the nozzle surface is a horizontal plane,
the upstream cover is disposed at a rear wall of the housing, and
the downstream cover is disposed at a front wall of the housing.

4. The recording device according to claim 1, comprising a control unit configured to control movement and stopping of the carriage, wherein
the control unit is configured to stop the carriage at a position such that the recording head is at the maintenance position, provided that the control unit receives an instruction from a user to perform maintenance on the recording head.

5. The recording device according to claim 1, wherein
the housing includes a locking member configured to be displaced between a locked state where at least one of the upstream cover and the downstream cover is locked in a closed state and an unlocked state where the locked state is released, and
the locking member is displaced from the locked state to the unlocked state when the recording head stops at the maintenance position.

6. The recording device according to claim 1, wherein
the carriage is configured to stop when at least one of the upstream cover and the downstream cover is in an open state.

7. The recording device according to claim 1, further comprising an illumination unit configured to illuminate the recording head at the maintenance position, wherein
the illumination unit is configured to be on when at least one of the upstream cover and the downstream cover is in an open state.

8. The recording device according to claim 7, wherein
the illumination unit is configured to be off when both the upstream cover and the downstream cover are in a closed state, and
the carriage is configured to start movement of the recording head to the cap position when both the upstream cover and the downstream cover are brought into a closed state from an open state.
